(19) United States
(12) Patent Application Publication
(10) Pub. No.: US 2022/0084141 A1
(43) Pub. Date: Mar. 17, 2022

(54) SYSTEMS AND METHODS FOR FACILITATING A MOBILE APPLICATION BASED RESTAURANT EXPERIENCE

(71) Applicant: Daniel J. Skinner, Reynoldsburg, OH (US)

(72) Inventor: Daniel J. Skinner, Reynoldsburg, OH (US)

(21) Appl. No.: 17/420,349

(22) PCT Filed: Feb. 3, 2021
(86) PCT No.: PCT/US21/16424

§ 371 Date: Jul. 1, 2021

Related U.S. Application Data
(60) Provisional application No. 62/969,812, filed on Feb. 4, 2020.

(51) Int. Cl. G06Q 50/12; G06Q 10/02; G06Q 30/06; G06Q 20/32; G06Q 20/10; G06F 16/2457

(52) U.S. Cl. CPC G06Q 50/12; G06Q 10/02; G06Q 30/0643; G06F 16/24575; G06Q 20/3223; G06Q 20/3267; G06Q 20/102; G06Q 30/0633

(57) ABSTRACT

Systems and methods for facilitating a mobile application based restaurant experience are provided. A virtual waiter and customer greeting may be generated at a customer and restaurant device upon arrival of the customer at the restaurant. As part of the virtual greeting, customers may indicate a desired level of interaction with an assigned waiter for their restaurant experience so that menu items may be ordered electronically or in person. Operations of the mobile application may be altered based on the type of service normally provided by the restaurant and/or user preference.

### CROSS-REFERENCE TO RELATED APPLICATIONS

This application claims the benefit of U.S. provisional patent application Ser. No. 62/969,812 filed Feb. 4, 2020, the disclosures of which are hereby incorporated by reference.

### TECHNICAL FIELD

Exemplary embodiments relate generally to systems and methods for facilitating a mobile application based restaurant experience.

### BACKGROUND AND SUMMARY OF THE INVENTION

Patrons at restaurants are typically sat at a table, or seat themselves, and wait for a server to come by to place their orders. Oftentimes, drinks and appetizer orders are taken first, followed by entrees, and later desserts. After the customer's meal is completed, the server may come back to clear the table and/or bring the bill, which is generally picked up by the server and processed to complete the meal. Busy customers are often left anxiously waiting for, or actively attempting to flag down, their server to place an order, receive their bill, pick up their check, or the like. This may lead to a less favorable dining experience. Restaurants are left with unrealized income as customer tables could be turned faster, leading to greater revenue. Remote ordering of food from a restaurant is known, including by way of applications installed on personal electronic devices. However, not all customers desire such a remote dining experience. And some customer's preferences may change based on their time constraints, type of restaurant, company (or lack thereof), combinations thereof, or the like. The global COVID-19 pandemic has provided an example of these changing preferences and the need for mobile application based restaurant experiences. Some restaurant customers or owners/operators may be uncomfortable with extensive in-person contact, and/or such contact may be restricted by health regulations or other rules, regulations, laws, or the like. Other customers or owners/operators may be less comfortable with operating the technology and may desire a certain amount of in-person contact. Therefore, a need remains to balance the desires of customers who prefer a more remote ordering experience with those who prefer more direct, face-to-face human interaction with their server.

Systems and methods are provided which facilitate a mobile application based restaurant experience. The systems and methods may provide a flexible user experience which is reflective of the user's preferences and desired type of restaurant experience. For example, operations of the mobile application may be altered based on the type of service normally provided by the restaurant and/or user preference. The systems and methods may provide the user with options to customize the amount of interaction they desire for a given dining experience. The systems and methods may provide the ability to call a human server as desired. The systems and methods may comprise applications which may be installed on customer's personal electronic devices and on restaurant devices, all of which may interact with one or more common servers.

The customer facing portions of the application may permit a customer to select restaurants, view and order menu items, pay for their meal, and leave feedback. Essentially, the customer may complete their dining experience by way of the application and have minimal interaction with the restaurant staff. This may permit faster table turns, reduce staffing requirements, and/or meet customer desires. At any time, the customer may call for a server. This may permit the customer to make special requests, troubleshoot problems, otherwise receive attention, and/or have a more traditional dining experience as desired. The customer may customize the amount of interaction they desire during their dining experience and the customer's server may be notified of the customer's preferences. The restaurant facing side of the application may provide lists of ordered items, tips received, and may provide customer assistance notifications.

The disclosed systems and/or methods may be utilized with respect to casual dining, fine dining, fast food dining, food courts, food trucks, movie theaters, sports stadiums, bars, buffets, coffee shops, hospitals, nursing homes, pick-up/carry out ordering locations, sports arenas, other food and/or beverage providers, combinations thereof, or the like. For example, without limitation, different types of food providers may need different features to service their customers. Each restaurant may be associated with a service level, such as but not limited to, minimum, mid-level, or full service. Upon selection of a minimum level service restaurant, the customer may be prompted to select and pay for their food, essentially providing a completely virtual restaurant experience. Upon selection of a mid-level service restaurant, the customer may be virtually greeted by an assigned waiter who may be periodically called for assistance, such as but not limited to, for assistance with food ordering, payment, or other customer needs. However, the customer may normally be prompted to order and pay for food in the application. In this way, the customer may be provided a semi-virtual restaurant experience. For example, without limitation, the experience may be virtual except where prompted by the customer. Upon selection of a full-service restaurant, the customer may select between more or less interaction with an assigned waiter. The waiter may be notified of the customer's selection such that the waiter may tailor his/her service accordingly. In exemplary embodiments, where less interaction is selected, the customer may be prompted to order and pay for food through the application. Where more interaction is selected, the application may await manual entry of food and payment information at a restaurant device associated with the assigned waiter. The waiter may be reminded to periodically check on the customer by electronic notification at the restaurant device. Reservations may also be made through the application, particularly for such full-service restaurants.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a plan view of an exemplary mobile ordering system in accordance with the present invention;

FIG. 2 is a plan view of an exemplary table identification system for the system of FIG. 1;

FIG. 3 is an exemplary login feature for the system of FIG. 1;

FIG. 3B is an exemplary new user sign up feature for the system of FIG. 1;

FIG. 3C is an exemplary social media login or signup process for use with the login feature of FIG. 3A and/or new user sign up feature of FIG. 3B;

FIG. 4 is an exemplary restaurant selection feature with connection options for the system of FIG. 1;

FIG. 4B illustrates another exemplary restaurant selection feature for the system of FIG. 1;

FIG. 4C illustrates another exemplary restaurant selection feature for the system of FIG. 1;

FIG. 4D illustrates additional restaurant information pages for use with the restaurant selection feature of FIGS. 4-4C;

FIG. 4E illustrates an exemplary sort or filter feature for the restaurant selection feature of FIGS. 4-4D;

FIG. 5 illustrates an exemplary notification feature for the system of FIG. 1;

FIG. 5B illustrates another exemplary notification feature for the system of FIG. 1;

FIG. 6 is an exemplary reservation feature for the system of FIG. 1;

FIG. 7 is an exemplary table selection feature for the system of FIG. 1;

FIG. 8 is an exemplary server identification feature for the system of FIG. 1;

FIG. 9 is an exemplary food selection feature for the system of FIG. 1;

FIG. 9B is another exemplary food selection feature for the system of FIG. 1;

FIG. 9C is another exemplary food selection feature for the system of FIG. 1;

FIG. 10 is an exemplary order summary feature for the system of FIG. 1;

FIG. 10B is another exemplary order summary feature for the system of FIG. 1;

FIG. 10C is another exemplary order summary feature for the system of FIG. 1;

FIG. 10D is another exemplary order summary feature for the system of FIG. 1;

FIG. 10E is another exemplary order summary feature for the system of FIG. 1;

FIG. 10F is another exemplary order summary feature for the system of FIG. 1;

FIG. 10G is another exemplary order summary feature for the system of FIG. 1;

FIG. 11 is an exemplary feedback feature for the system of FIG. 1;

FIG. 11B illustrates another exemplary feedback feature for the system of FIG. 1;

FIG. 12 is an exemplary new customer feature for the system of FIG. 1;

FIG. 13 is an exemplary order receipt feature for the system of FIG. 1;

FIG. 14 is an exemplary meal completion feature for the mobile ordering system of FIG. 1;

FIG. 15 is an exemplary customer assistance notification for the mobile ordering system of FIG. 1;

FIG. 16 illustrates an exemplary dashboard for use with the system of FIGS. 1-15;

FIG. 17 illustrates a flow chart with exemplary dashboard for operating an application in accordance with the present invention;

FIG. 17B illustrates a continuation of the flow chart or FIG. 17;

FIG. 18 illustrates a flow chart with exemplary logic for operating various types of food providers in accordance with the present invention; and

FIG. 18B continues the flow chart of FIG. 18.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

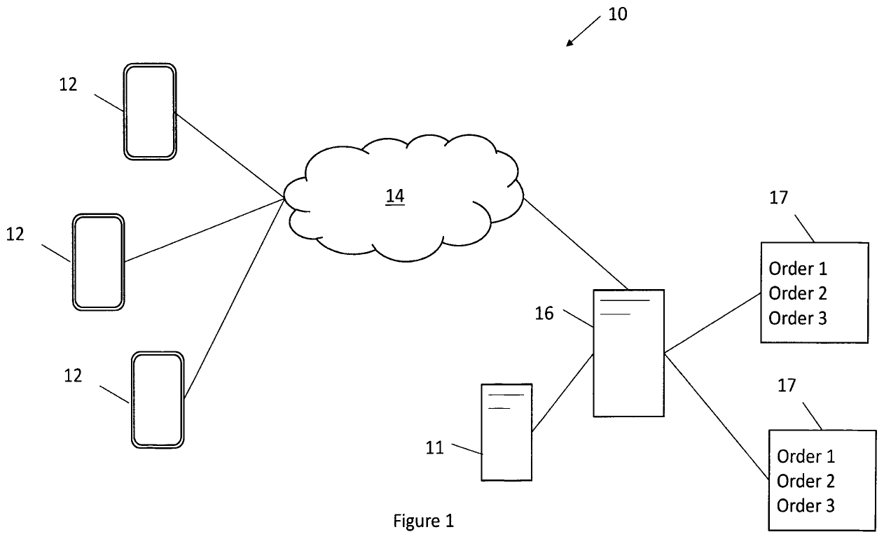

FIG. 1 is a plan view of an exemplary mobile ordering system 10 in accordance with the present invention. The system 10 may comprise one or more customer devices 12. The customer devices 12 may comprise personal electronic devices such as, but not necessarily limited to, smartphones, laptops, tablets, computers, electronic displays, some combination thereof, or the like. The system 10 may comprise one or more servers 16. The servers 16 may comprise one or more processors, electronic storage devices, displays, some combination thereof, or the like.

Each of the customer devices 12 may be in electronic communication with the servers 16 by way of one or more networks 14. The networks 14 may comprise one or more internets, intranets, cellular networks, some combination thereof or the like. The networks 14 may include the world wide web, for example without limitation. Such connections may be made by way of wired connections, wireless connections, some combination thereof, or the like.

The server 16 may be configured to host an application installed on and/or accessed by the customer devices 12. For example, some or all of the application may be installed on each of the customer devices 12. In other exemplary embodiments, some or all of the application may be hosted on the severs 16 and accessible on the customer devices 12 by way of the networks 14.

One or more restaurant devices 17 may be in electronic communication with the servers 16. The restaurant devices 17 may include, for example without limitation, computers, laptops, smartphones, tablets, electronic displays, some combination thereof, or the like. Restaurant devices 17 for each of a number of restaurants, or a single restaurant, may be in electronic communication with the severs 16. Some or all of the application may be installed on each of the restaurant devices 17. In other exemplary embodiments, some or all of the application may be hosted on the severs 16 and accessible on the restaurant devices 17 by way of the networks 14.

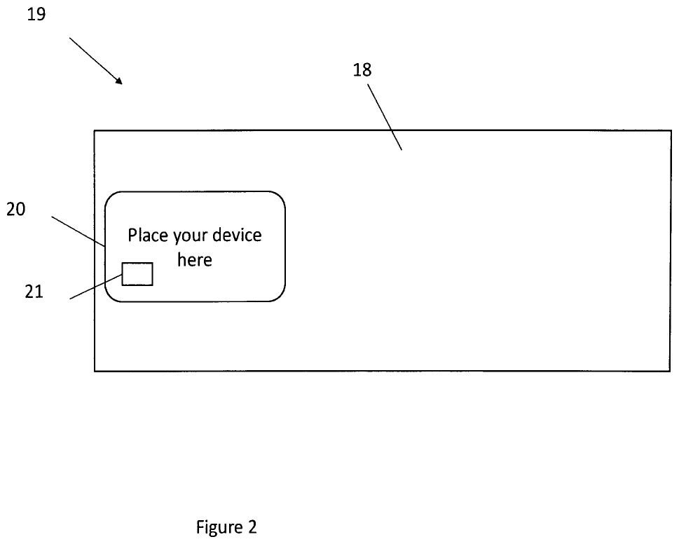

FIG. 2 is a plan view of an exemplary table identification system 19 for the mobile ordering system 10. A customer table 18 may comprise one or more designated areas 20 for placement of the customer's personal electronic device 12. The designated areas 20 may comprise baskets, mats, markers, some combination thereof, or the like. The designated areas 20 may comprise one or more interface devices 21 configured to communicate with the personal electronic device 12. Such interface devices 21 may comprise near field communication devices such as but not limited to those operating by way of Bluetooth® protocols. In other exemplary embodiments, the designated areas 20 may be an area for the customer to place their personal electronic device 12 with a displayed order number 31 such that the server may locate or confirm the appropriate table for serving an order as further described herein. In other exemplary embodiments, the customer and/or their table may be described in the application by an identification number, description, photo, some combination thereof, or the like. In such embodiments, the table identification system 19 may not be required.

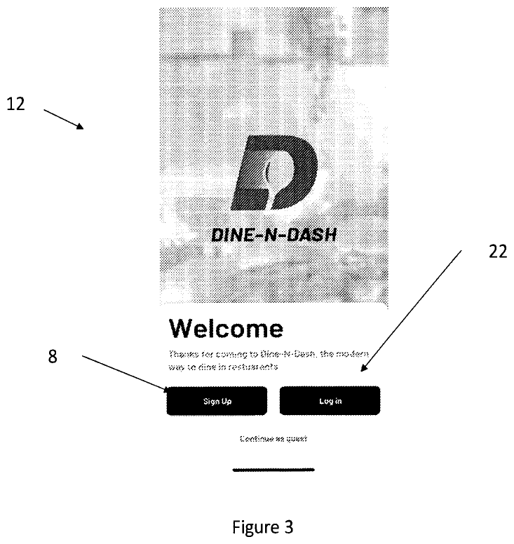

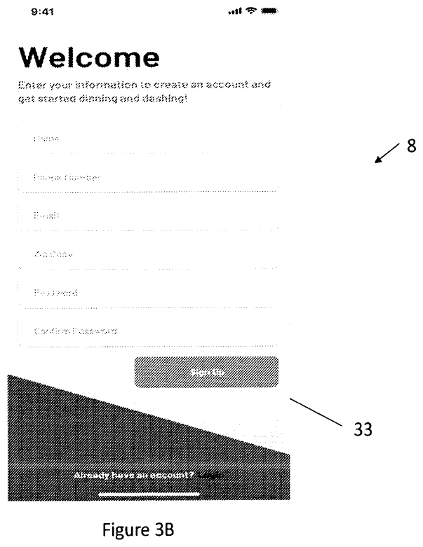

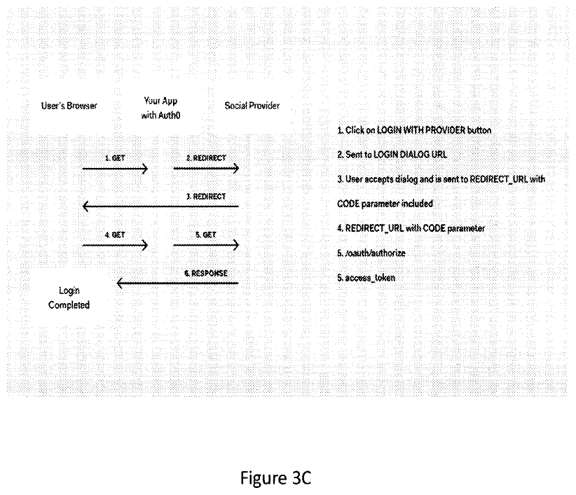

FIG. 3 is an exemplary login feature 22. An existing customer may be prompted to enter a user name and password, for example without limitation, to log into an existing account. New customers may be permitted to create an account. Options to check out as a guest may be provided. Other login options may include various biometric verification measures such as but not limited to, finger print identification, facial recognition technology, iris scanning technology, some combination thereof, or the like.

New users may be prompted to select a signup option 8.

As illustrated in FIG. 3B, upon selecting the signup option 8, the user may be prompted to enter certain personal information including, but not limited to name, mobile phone number, zip code, photo, combination thereof, or the like.

In exemplary embodiments, the first name and last name entries may contain only alphabets and no numbers or special character may be allowed. The first letter of these two may be of capital letters (this may be done automatically by the app even though the user provides a small letter). The mobile number and zip code validation-Mobile number may be of 10 digits (This field may allow only digits) and zip code (which may only allow digits) shall be of 5 digits. If not then a signup button 33 may not be enabled. The signup button 33 may be disabled until all above validation criteria passes.

If all the above validation passes then the signup button 33 may be enabled. When actuating the signup button 33, registration may be done successfully and the user may be logged in and redirected to a home screen, which may include for example without limitation, a restaurant selection page 24.

If any network error occurs during sign up then a message conveying the error may be generated for display. The application may be configured to only permit one to register with one email ID & mobile number.

During the signup and/or login process an email verification and/or one-time-passcode may be utilized to verify the user's identity.

Alternatively, or additionally, the user may sign up or login using a social media account as shown with regard to FIG. 3C.

The same or similar sign up and/or login process may be undertaken for a restaurant, such as by using the application on one of the restaurant devices 17. The restaurant facing enrollment, however, may gather additional information including the location of the restaurant, menu information, seating information, hours of operation, permit electronic upload of photos of menu items, restaurant exterior and interior, combinations thereof, or the like. Options for uploading documentation regarding, for example without limitation, vendor's license, food license, liquor license (if applicable), employer identification number, combinations thereof, or the like may be provided.

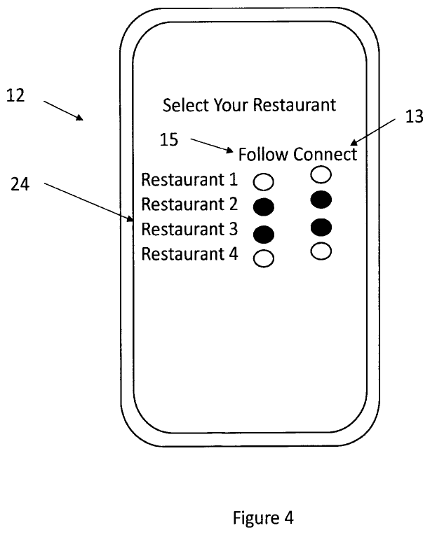

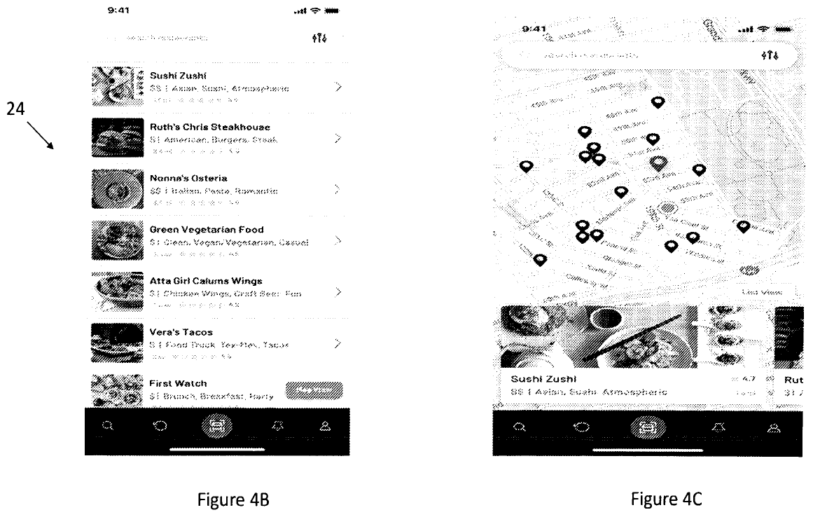

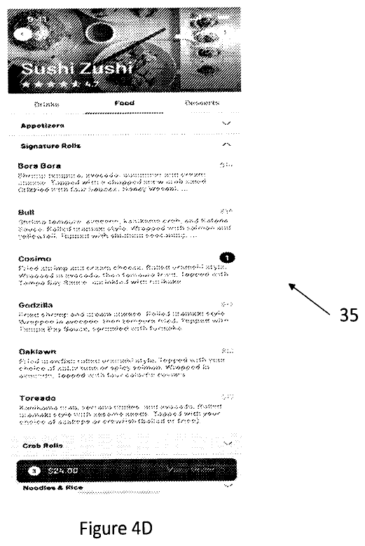

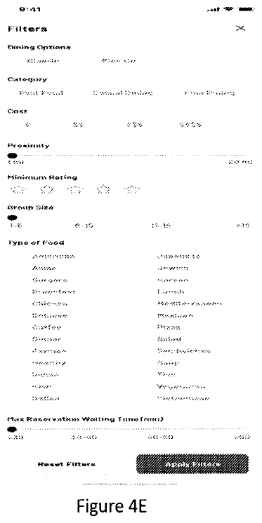

FIG. 4 is an exemplary restaurant selection page 24. The restaurant selection page 24 may serve as some or all of a home screen. A list of restaurants for ordering may be provided. The list may be populated by distance from the customer's personal electronic device 12, other selected location, search term, favorites, previously visited restaurants, promoted restaurants, some combination thereof, or the like. The customer may be prompted to select a restaurant. In other exemplary embodiments, the restaurant may be automatically selected by the location of the customer device 12 and/or by information transmitted from the designated area 20. The locations of the customer device 12 may be determined by an integrated location tracking device, may be manually inputted, some combination thereof, or the like. The location of the designated area 20 may be preprogrammed and transmitted to the server 16 by way of the customer device 12.

Various options to connect with one or more of the listed restaurants may be provided. In exemplary embodiments, a follow feature 15 may be provided. The follow feature 15 may be configured to accept user input indicating a desire to follow, like, or otherwise receive communications from and/or transmit communications to or about particular restaurants, such as but not limited to those provided at the restaurant selection features 24. Such communications may include advertisements, promotions, notifications regarding restaurant availability, menu changes, combinations thereof, or the like.

Alternatively, or additionally, a connect feature 13 may be provided. The connect feature 13 may be configured to accept user input indicating a desire to connect various communication platforms with particular restaurants, such as but not limited to those provided at the restaurant selection features 24. Such communication platforms may include, but are not limited to, social media platforms, email, automated calls, text messages, electronic notifications, some combination thereof, or the like.

The follow and/or connect features 15 and 13 may be provided at other areas or locations of the application.

FIG. 4B illustrates another exemplary restaurant selection feature 24 which may alternatively serve as the home screen. The restaurant selection feature 24 may display information regarding particular restaurants meeting certain criteria. For example, without limitation, restaurants within certain proximity, with higher ratings, within a given budget/price range, selected for following by the user, previously visited by the user, not previously visited by the user, visited by other users associated with a given user, popular with users, selected by an administrator (such as promoted or sponsored restaurants), having availability, special options (e.g., vegan, gluten free) combinations thereof, or the like, may be selected for display. In exemplary embodiments, such information may be stored in the database 11 and retrieved by the server 16 as needed to generate the list of restaurants in the restaurant selection feature 24. In other exemplary embodiments, such a listing of restaurants may be provided as a default option. The default display may be altered based on promoted restaurants, customer order history, customer preferences, filter or sort options, combinations thereof, or the like. Each restaurant in the restaurant selection feature 24 may be represented graphically by name, photo, icon, symbol, combinations thereof, or the like.

As illustrated in FIG. 4C, in other exemplary embodiments the restaurant selection page 24 may appear as a visual depiction of a map with one or more selectable icons representing restaurants or other food providers.

Further information about each restaurant may be displayed upon selection by the user of a given one of the restaurants listed in the restaurant selection feature 24. Such information may include, for example without limitation, a listing of menu items available 35 from the restaurant such as shown in FIG. 4D.

As illustrated in FIG. 4E, restaurants displayed may be filtered or sorted based on user selection, such as but not limited to, location, proximity, waiting time, group size and availability, type of food, price range, rating, atmosphere, combinations thereof, or the like.

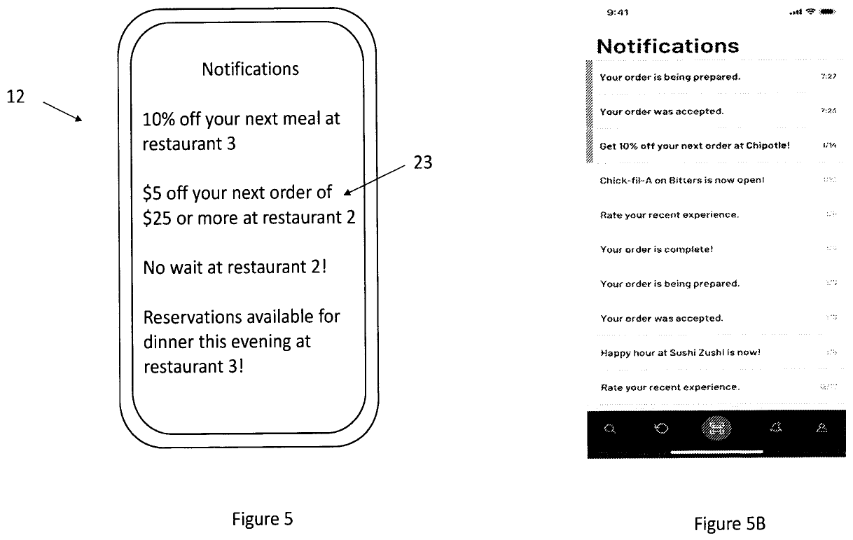

FIG. 5 and FIG. 5B illustrate exemplary notification features 23.

The notification feature 23 may be configured to generate one or more alerts at the customer device 12 for the customer. Such notifications may include, for example without limitation, discounts or other incentives for a given restaurant, that a short or no wait is currently required for a particular restaurant, or that reservations are available at a particular restaurant. The notifications generated may be based on user preferences, user activity, restaurant preferences, restaurant activity, predetermined criteria, random selection, some combination thereof, or the like. In exemplary embodiments, the notification feature 23 is configured to generate such notifications at the customer devices 12 associated with customers who have opted to follow and/or connect with the given restaurant by way of the follow feature 15 and/or the connect feature 13. The notification feature 23 may, in exemplary embodiments, interface with the notification system of the customer device 12.

In exemplary embodiments, the availability of reservations, wait time, and the like may be determined from reservation data, current order information, capacity information, combinations thereof, or the like stored at the database 11 and analyzed by the server 16.

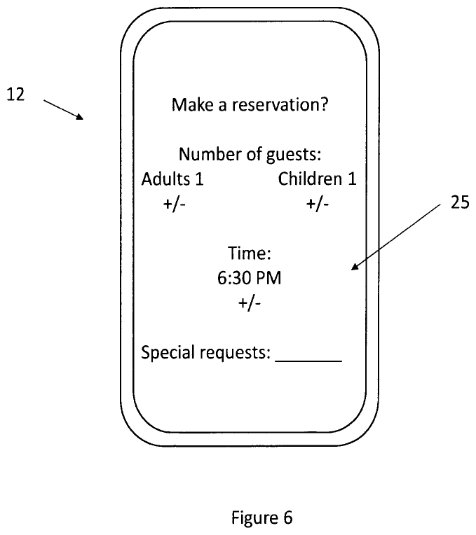

FIG. 6 is an exemplary reservation feature 25. The reservation feature 25 may be configured to accept user input regarding a reservation (e.g., date, time, number of people, contact information, combinations thereof, and the like) to be entered into a database 11 and associate the reservation data with the restaurant device 17. The database 11 may be in electronic communication with the server 16. In exemplary embodiments, the reservation feature 25 may be configured to receive user input indicating the number of guests, such as but not limited to, adult guests and children. Additionally, or alternatively, the reservation feature 25 may be configured to receive user input indicating the desired reservation time and/or any special requests.

The reservation feature 25 may be configured to automatically determine reservation availability based on other stored reservations in comparison to the known restaurant seating accommodations, restaurant operating hours, combinations thereof, or the like. The reservation feature 25 may, alternatively or additionally, determine reservation availability based on predictions, such as but not limited, to known trends, time (breakfast, lunch, dinner rush, or the like), weather (inclement weather tending to result in more people dining in), combinations thereof, or the like. Reminder notifications at predetermined intervals before, or at the time of, the reservation may be provided.

The database 11 may be configured to store other information for operating the customer and/or restaurant facing sides of the application including, but not limited to, customer information, restaurant information, menu information, administrator credentials, payment information, order information, transaction information, combinations thereof, or the like. Customer information may comprise, for example without limitation, customer identification (e.g., name, photo, combinations thereof, or the like), contact information, customer preferences (e.g., price range, type of restaurant, favorite restaurants, combinations thereof, or the like). The restaurant information may comprise, for example without limitation, operating hours, urgent availability/unavailability, approximate wait times, location, contact information, seating capacity, waiter working hours, waiter table assignment information, coupons or promotions, combinations thereof, or the like. Menu information may comprise, for example without limitation, menu items, prices, coupons or promotions, combinations thereof, or the like. Administrator credentials may comprise, for example without limitation, permission information associated with particular restaurants. Payment information may comprise, for example without limitation, credit card information, debit card information, prepaid card information, bank information, combinations thereof, or the like. Order information may comprise, for example without limitation, current or prior orders of various menu items. Transaction information may comprise, for example without limitation, orders, reviews, payment information (e.g., subtotals, prices paid, tips, taxes, fees, combinations thereof, or the like), preferences selected, combinations thereof, or the like for a given order and/or restaurant experience. The database 11 may be organized or structured to associate particular information with particular customers, restaurants, waiters, administrators, combinations thereof, or the like. The database 11 may comprise one or more electronic storage devices.

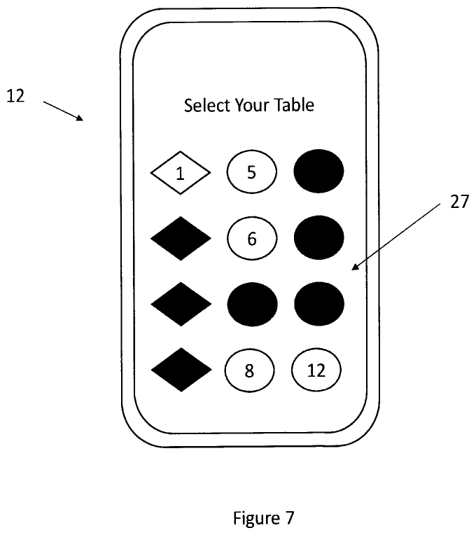

FIG. 7 is an exemplary table selection feature 27. In exemplary embodiments, the table selection feature 27 may be provided as a part of the reservation feature 25, though such is not required. A floor plan preferably reflecting the layout of the restaurant and available customer tables 18 may be provided, though a generic layout may be used in other embodiments. Available and unavailable customer tables 18 may be indicated, such as but not limited to by, darkening unavailable customer tables 18 and showing available customer tables 18 as outlines, color coding, combinations thereof, or the like. The customer tables 18 may be denoted with an identifier, such as but not limited to, an alphanumeric marking.

The same or similar feature may be provided on the restaurant facing side of the application at the restaurant devices 17 to indicate which tables are occupied and which are available, though such is not required.

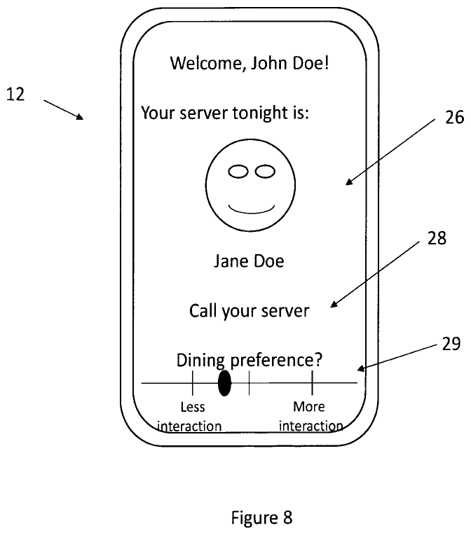

FIG. 8 is an exemplary waiter identification feature 26. The customer may be virtually greeted by his or her waiter. The server may be automatically assigned to the customer based on customer preferences, customer table 18 location, server workload, restaurant needs, combinations thereof, or the like. The server's name and photo may be displayed. An option to call the server 28 may be generated. The option to call the server 28 may be provided as a pop-up, a banner, some combination thereof, or the like. In exemplary embodiments, the option to call the server 28 may be provided across all customer facing features of the application.

Alternatively, or additionally, the option to call the server 28 may comprise instructions for calling the waiter. Such instructions may include, but are not limited to, swiping in a particular direction, double tapping, tap and holding for a period of time, providing certain gestures, some combination thereof, of the like. The application may be configured to periodically or constantly monitor for such user input. Upon receipt of such user input, the application may be configured to automatically generate a notification which is transmitted to the restaurant device 17 associated with the assigned server. This way, if the customer has difficulty ordering, needs attention, or otherwise desires face-to-face human interaction with the server, the customer may do so at any time. For example, without limitation, the customer may wish to make a special request for their food preparation that may not be otherwise provided for on a food selection feature 30. As another example, without limitation, the customer may desire a refill of their beverage, condiments, toppings, clarification about a menu item, voice complaints or praise, some combination thereof, or the like, which may be better facilitated by face-to-face interaction with the server.

A dining preference selection tool 29 may be provided. The dining preference selection tool 29 may permit the customer to elect to have more or less face-to-face interaction with their server. For example, without limitation, the dining preference selection tool 29 may be provided as a slider which permits the customer to select between more or less face-to-face interaction. In other exemplary embodiments, the dining preference selection tool 29 may comprise radio buttons, numerical ratings, some combination thereof, or the like.

The dining preference selection tool 29 may affect the customer's dining experience. In exemplary embodiments, the user selection at the dining preference selection tool 29 may be transmitted to the restaurant device 17 for the assigned waiter, so the waiter may adjust his or her services. Alternatively, or additionally, the flow through the application may be adjusted based on the user selection at the dining preference selection tool 29. For example, without limitation, the user may be prompted to order and pay for food in the application where the user selects less interaction. As another example, without limitation, no such prompt may be provided and instead the application may prompt the restaurant device 17 associated with the waiter to enter the user's food order and payment information. The restaurant device 17 associated with the waiter may, alternatively or additionally, remind the waiter to check on the customer more of less often based on the user selection at the dining preference selection tool 29.

The application may be further configured to, for customers who opt in, automatically identify the user as dining at the restaurant to other users of the application associated with the user.

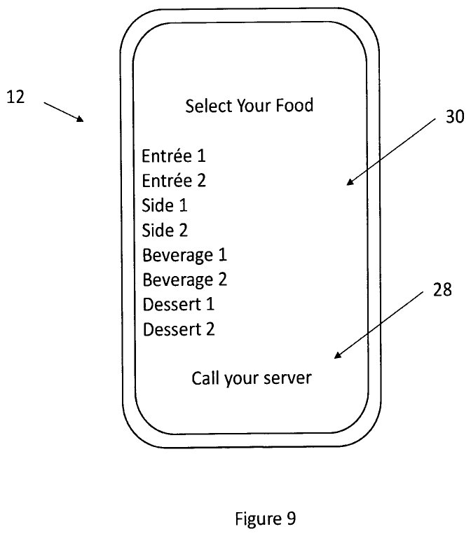

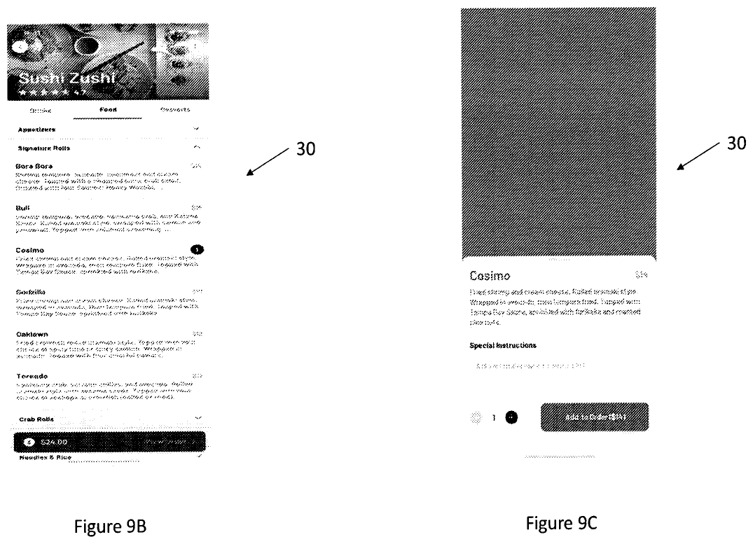

FIG. 9 through FIG. 9C illustrate exemplary food selection features 30. The restaurant's menu may be displayed, such as upon selection at the restaurant selection feature 24. Descriptions, photos, some combination thereof, or the like may be provided. The user may be prompted to select one or more food items, sides, preparation details, or the like to generate an order. Selected items may be added to a virtual shopping cart for ordering.

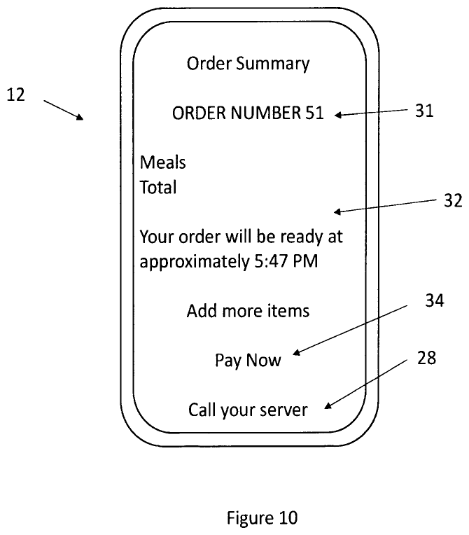

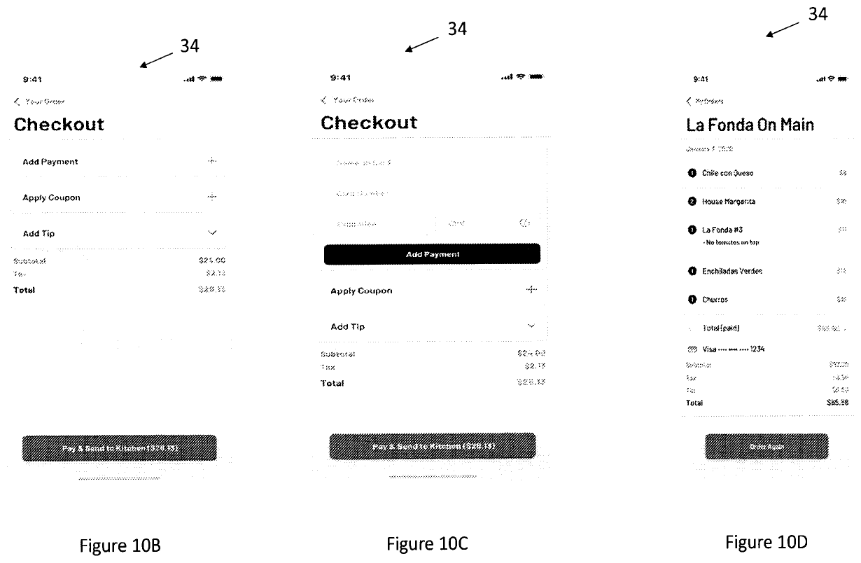

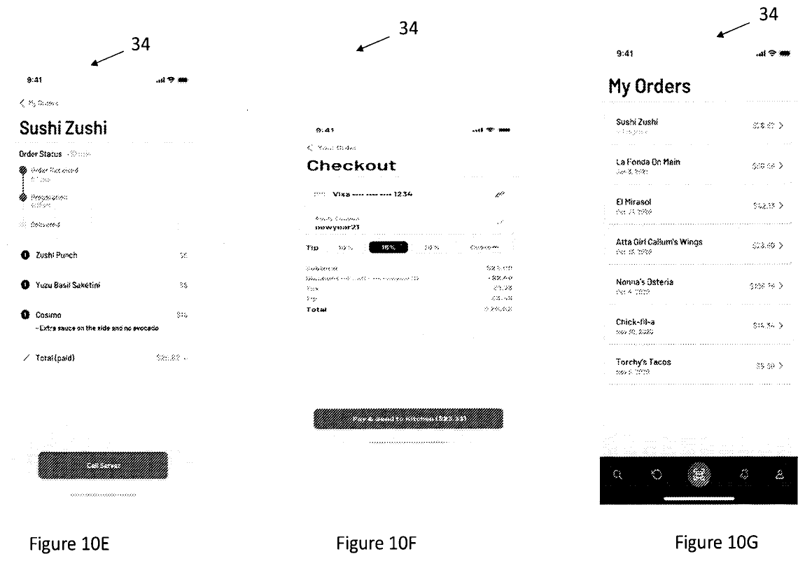

FIG. 10 through FIG. 10G illustrate exemplary order summary and status features 32. The order summary and status features 32 may comprise an order number 31. In other exemplary embodiments, the order number 31 may be displayed separately. The meal items ordered, such as from the food selection feature 30, may be listed along with a total for the order. The total may include any applicable taxes as well as any user provided tip. The approximate time the order will be ready may be provided.

An option to complete payment 34 may be provided. Payment options may include cash, credit card, electronic check, or third-party payment systems, such as but not limited to PayPal®, ApplePay™, some combination thereof, or the like. The payment option 34 may include the ability to add a tip. Such third-party payment systems may be linked to the personal electronic devices 12 and the restaurant devices 17 through one or more remote servers which may be in electronic communication with the application server(s) 16.

The order summary and status feature 32 may include an estimated time or time range the order will be completed, such as but not limited to, based on the number of orders already pending, the time (lunch or dinner rush being slower, or the like), a predetermined amount, combinations thereof, or the like, data for which may be stored at the database 11 and analyzed by the server 16. In other exemplary embodiments, the time or range may be manually entered or adjusted at the restaurant facing side of the application. A countdown time to order ready may be provided. A notification may be generated when the time is reached, or the restaurant indicates that the food is ready on the restaurant facing portion of the application. Reminders may be generated for unpicked up or undelivered food.

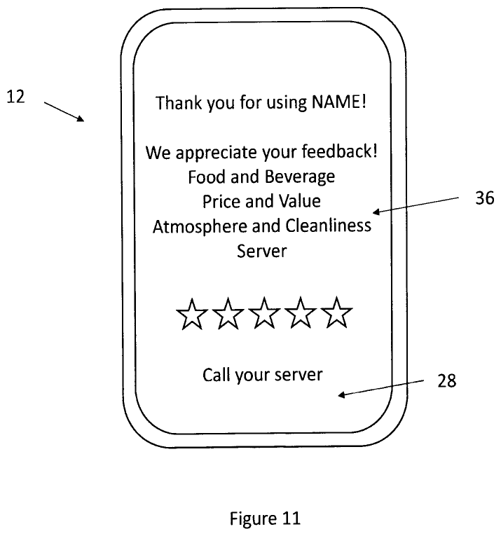

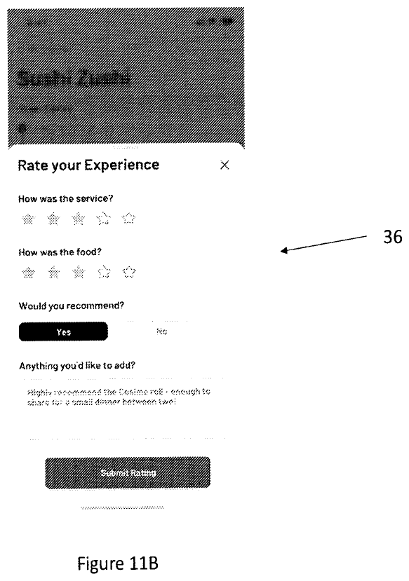

FIG. 11 and FIG. 11B illustrate exemplary feedback features 36. After a dining experience is completed, the customer may be prompted to provide feedback regarding their experience. Categories of feedback to be provided may comprise, for example without limitation, food and beverage, price and value, atmosphere and cleanliness, waiter, combinations thereof, or the like. The feedback may be star rating, number rating, good/bad, comments, some combination thereof, or the like. The feedback feature 36 may include the ability to add a tip.

Certain rating or feedback categories may be applied specifically for the restaurant and/or the waiter. For example, without limitation, the following rating or feedback categories may be provided to the waiter: appearance, friendliness, knowledge, service, comments, combinations thereof, or the like.

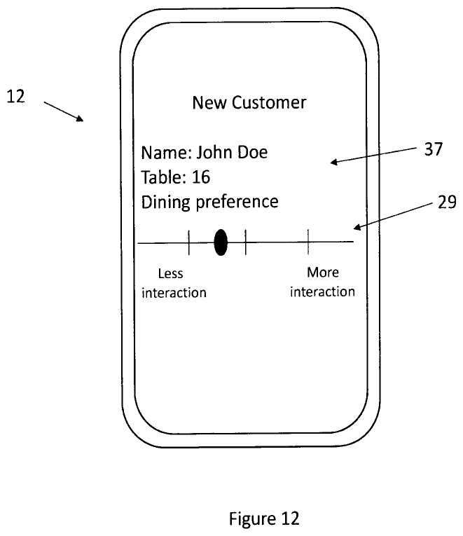

FIG. 12 is an exemplary new customer feature 37. When a new customer is assigned to a given waiter, the restaurant device(s) 17 associated with the assigned server may be configured to generate and display the new customer feature 37 at such associated ones of the restaurant devices 17. The new customer feature 37 may comprise identification information for the customer such as, but not limited to, a name, description, photo, some combination thereof, or the like. Table identification information such as, but not limited to, a number, description, photo, some combination thereof, or the like may be provided. The customer's dining preferences may be provided, such as but not limited to, the selection made by the customer at the dining preference selection tool 29. This may prompt the waiter to tailor his/her services accordingly. For example, without limitation, if more interaction is requested, the server may preemptively greet the customer and offer to take their order directly, engage the customer more often, and/or check in on the customer more often. For example, without limitation, if less interaction is requested, the server may wait to allow the customer to order by way of the application, engage the customer less often, and/or check on the customer from a distance.

Alternatively, or additionally, the application may be configured to adjust server assignments based on the amount of interaction requested. For example, without limitations, where a particular server is assigned customers who want more interaction, less new customers may be assigned as the server is more likely to be busy. As a further example, without limitation, where a particular server is assigned customers who want less interaction, more new customers may be assigned as the server is less likely to be busy. In this way, restaurant staffing and operations may be optimized.

In exemplary embodiments, where a desire for more interaction is indicated at the dining preference selection tool 29, the servers 16 may be configured to generate electronic notifications at the restaurant devices 17 associated with the assigned server reminding the assigned server to check-in with the customer with a greater frequency than where a desire for less interaction is indicated at the dining preference selection tool 29.

Alternatively, or additionally, operation of the application may be altered based on user selections made at the dining preference selection tool 29. For example, without limitation, where more user interaction is indicated at the dining preference selection tool 29, the application may display the food selection feature 35, payment feature 34, combinations thereof, or the like at the restaurant device 17 for the waiter to enter at his/her associated restaurant device 17.

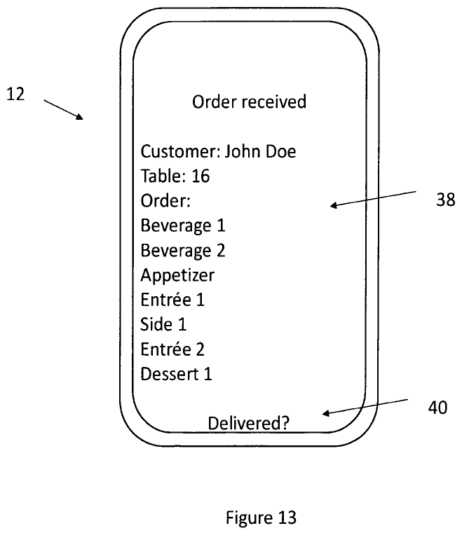

FIG. 13 is an exemplary order receipt feature 38. The order receipt feature 38 may be displayed at the restaurant device(s) 17 associated with the restaurant and/or the server for which the order was placed with which the order was placed. The order receipt feature 38 may comprise the customer identification information (such as but not limited to name, description, photo, some combination thereof, or the like), the table identification information (such as but not limited to name, description, photo, some combination thereof, or the like), and the order details (such as but not limited to, the food ordered and any preparation details or other special instructions provided by the customer).

A delivery prompt 40 may be provided requesting the server to indicate that the ordered meal, or a portion thereof, has been delivered to the customer. In exemplary embodiments, the order receipt feature 38 may be displayed only after the user has completed their order. The selection of the delivered option 40 may initiate the customer facing portion of the application to display the feedback feature 36. A similar feature may be used to indicate food picked up by the customer.

The order receipt feature 38 may comprise an option for rejecting received orders. Upon such rejection, the customer may automatically not be charged and/or a refund for the order may be automatically issued. An electronic notification regarding the same may be automatically generated and send to the user's device 12.

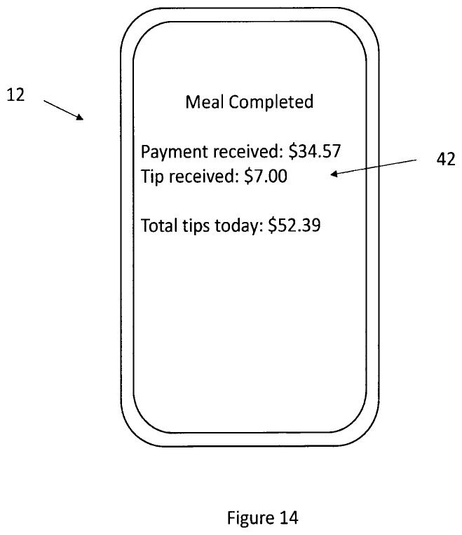

FIG. 14 is an exemplary meal completion feature 42. The meal completion feature 42 may be displayed at the restaurant device(s) 17 associated with the server with whom the order was placed. The meal completion feature 42 may comprise an indication of payments received for the order, tips received, a total amount of tips received for a given period (such as but not limited to a day, shift, pay period, month, year, some combination thereof, or the like), some combination thereof, or the like. The meal completion feature 42 may include a display of feedback received at the feedback feature 36.

Upon completion of a restaurant experience and/or one or more orders, some or all of the details gathered during the restaurant experience and/or one or more transaction may be stored in the database 11. Such details may be stored for a period of time and for later access. For example, without limitation, restaurant users, such as but not limited to, waiters and/or administrators, may access a list of completed restaurant experiences and/or orders specific to the waiter or restaurant, respectively. Similarly, customer users may access a list of completed restaurant experiences and/or orders specific to the customer. Such prior history may be accessible at the order summary and status feature 32 for the customer, the order receipt feature 38 for the waiter or restaurant, a home page, a dashboard 50, combinations thereof, or the like. Details of a prior restaurant experience and/or order may be accessed upon selection of the same.

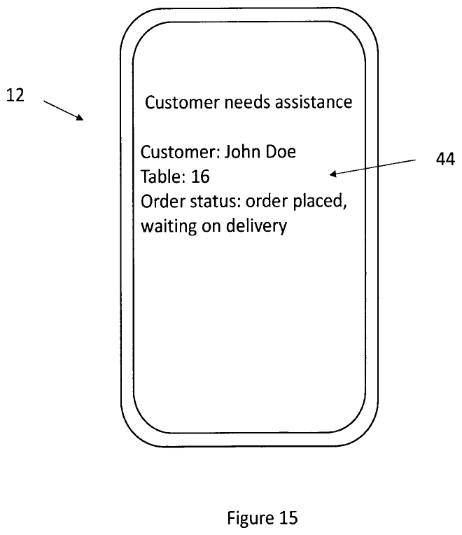

FIG. 15 is an exemplary customer assistance notification 44. Upon customer selection of the waiter call option 28, the customer assistance notification 44 may be generated and displayed at the restaurant device(s) 17 associated with the server with which the order was placed. The customer assistance notification 44 may comprise customer identification information (such as but not limited to a customer name, photo, or other description), a table identification (such as but not limited to a number or other description), an order status, some combination thereof, or the like. The order status may permit the server to better anticipate the customer's possible need for assistance. For example, without limitation, or no order has been placed, the server may come ready to take an order for the customer. If an order has been placed, but is waiting on preparation, the server may check with the kitchen staff prior to approaching the customer, may come ready with water pitchers for refiling drinks, or additional items such as but not limited to complementary dinner rolls to satisfy the customer while they are waiting for their food.

In exemplary embodiments, FIGS. 3-11B represent customer facing pages, portions, and/or features of the application while FIGS. 12-15 represent restaurant and/or server facing pages, portions, and/or features of the application, though such is not required.

Information associated with the application may be stored locally (e.g., at the customer devices 12 and/or the restaurant devices 17), remotely (e.g., at the databases 11, servers 16), some combination thereof, or the like.

Each of the features, items, categories, displays, data, representations, some combination thereof, or the like may be displayed on a single page, on separate pages, within pop-up boxes, in various arrangements, in combination with one another, separate from one another, some combination thereof, or the like.

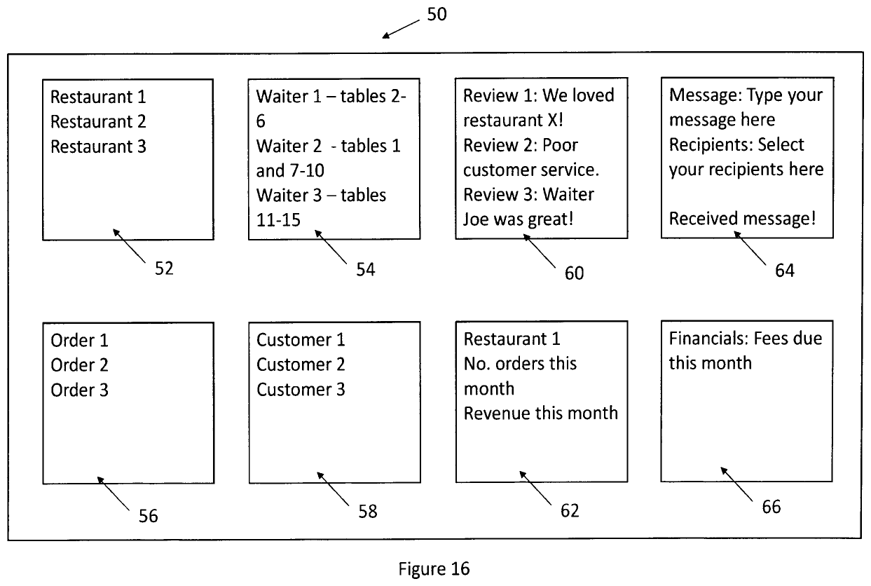

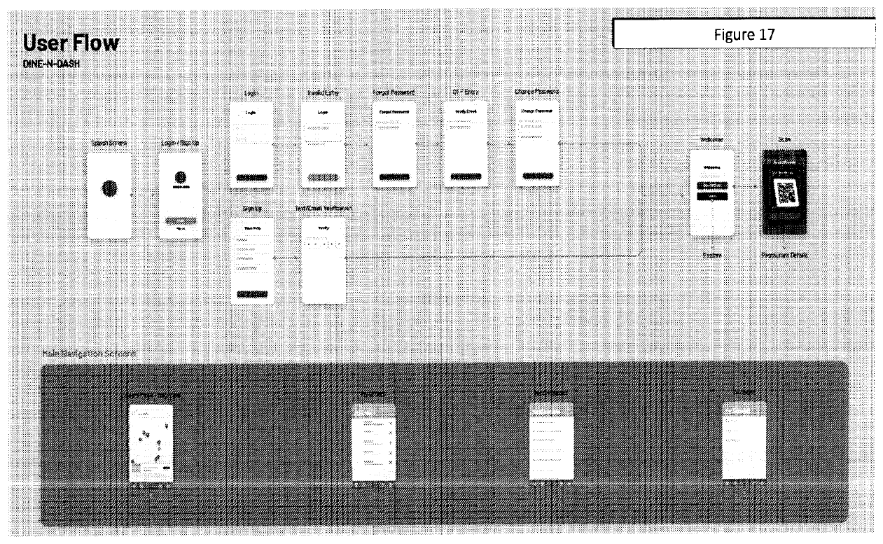

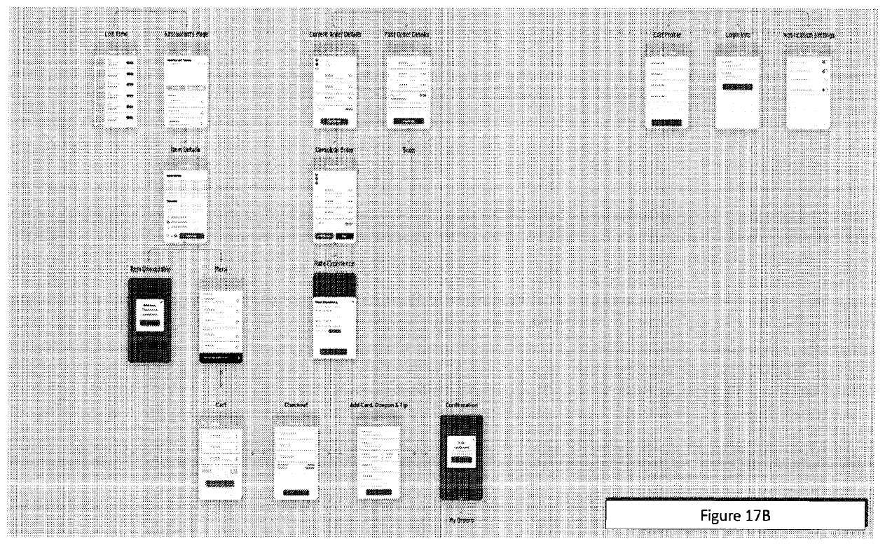

FIG. 16 illustrates an exemplary dashboard 50 for managing the restaurant and/or customer facing portions of the application. The dashboard 50 may be available to an application administrator for one or more partner restaurants, and the information displayed may be associated with the one or more partner restaurants associated within the credentials of the administrator. In this way, the data may be parsed and displayed solely as is relevant for the particular administrator, which may be a restaurant owner or operator, for example. The dashboard 50 may comprise one or more website accessible portals hosted on the application server(s) 16. The dashboard 50 may comprise options for managing restaurant partners 52, managing waiters 54, managing orders 56, managing customers 58, review and ratings 60, analytics and reporting 62, messaging and communications 64, and financials 66. In exemplary embodiments, the dashboard 50 may be configured to provide information specific to a given restaurant.

The managing restaurant partners area 52 of the dashboard 50 may comprise a grid view of partnered restaurants. Selection of a given partner restaurant may provide detailed information, such as but not limited to sales and other financial information. At managing restaurant partners area 52 of the dashboard 50, an administrator may be able to add or remove particular partnered restaurants, add coupons or promotional codes for particular partnered restaurants which are pushed to customer devices 12 such as by way of texts, push notifications, combinations thereof, or the like. Such coupons or promotions may be provided to all partner restaurants within a given city area and/or zip code. The dashboard 50 may also permit administrators to edit menu options for partner restaurants.

For coupons/offers, the administrator may specify the discounted amount that will be borne by a restaurant, the amount of the discount, the terms of the discount (including but not limited to any minimum or maximum transaction amount), how long the promotion remains in effect, the number of times a promotional code may be utilized, combinations thereof, or the like.

The managing waiters area 54 may provide a listing of waiters associated with one or more partner restaurants, customers assigned, tables assigned, dates and times of working hours, revenue generated from orders associated with the waiters, combinations thereof, or the like.

The managing order areas 56 and managing customer areas 58 may permit administrators to add, remove, or edit orders or customers, respectively. The managing reviews area 60 may permit administrators to hide certain review, make other review public, mark certain review as spam, combinations thereof, or the like. The managing reviews area 60 may allow the administrator to provide compensation to customers reporting negative reviews, including but not limited to, money, gift cards, promotional coupons, combinations thereof, or the like.

The analytics and reporting area 62 may permit administrators to track one or more partner restaurants and generate reports comprising, for example without limitation, restaurant revenues, orders, customers, combinations thereof, or the like.

The messaging and reporting area 64 may permit administrators to send messages to particular devices 12, 17 associated with particular partner restaurants, customers, waiters, combinations thereof, or the like.

The financials area 66 may provide information regarding certain amounts of money owing.

Screen provided may comprise, for example without limitation, the following generalized categories of screens and relevant information related to the same. On the customer facing side of the application, a login screen, signup screen, forgot password/change password screen, default home page (List of Restaurants), restaurant and its menu page, cart page, apply coupon page, invoice page, payment page, add card details page, feedback screen, my account, past order list, last order details page, search criteria popup, referral screen, prompt for the number of seats to be booked, combinations thereof, or the like. On the restaurant facing side of the application, a login screen, signup screen, forgot password/change password screen, home page/ongoing orders, detailed order screen (the same screen will be used for past order detailed screen as well), past order, add menu screen, view menu screen, edit menu, setting page, my account (pending payment amount page), combinations thereof, or the like. Certain screens may be common to both the restaurant facing and customer facing sides of the application and include, for example without limitation, a splash screen, logo, story board, combinations thereof, or the like. Any of the screens shown and/or described herein may be provided on the restaurant facing side of the application, customer facing side of the application, both, or the like.

Various restaurants, customers, waiters, administrators, combinations thereof, of the like may be added, removed, blocked, provided access, combinations thereof, or the like at the dashboard 50.

FIG. 17 and FIG. 17B illustrates a flow chart with exemplary logic for operating an application on the customer side. Various exemplary progressions through an application installed on a customer device 12 are provided by way of example and are not intended to be limiting.

The systems and/or method shown and/or described herein may be utilized with respect to a number of food providers including but not limited to, groceries, restaurants, casual dining, fine dining, fast food dining, food courts, food trucks, movie theaters, sports stadiums, bars, buffets, coffee shops, hospitals, nursing homes, pick-up/carry out ordering locations, sports arenas, other food and/or beverage providers, combinations thereof, or the like.

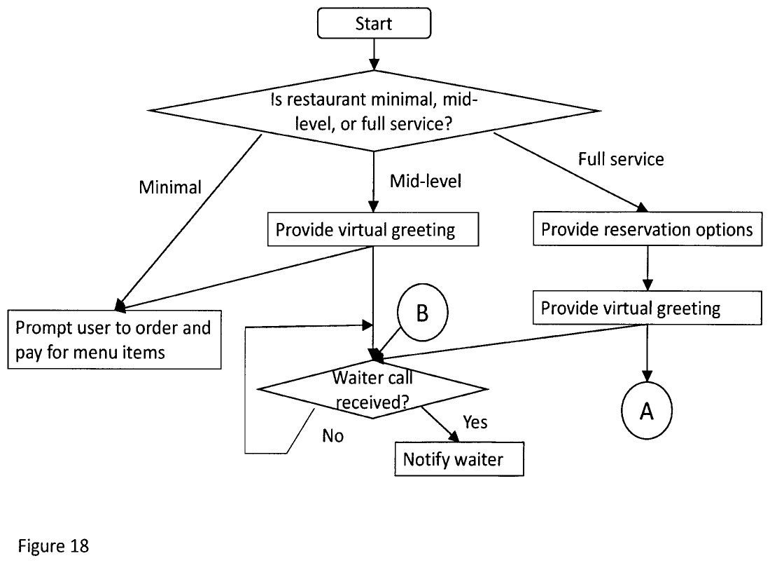

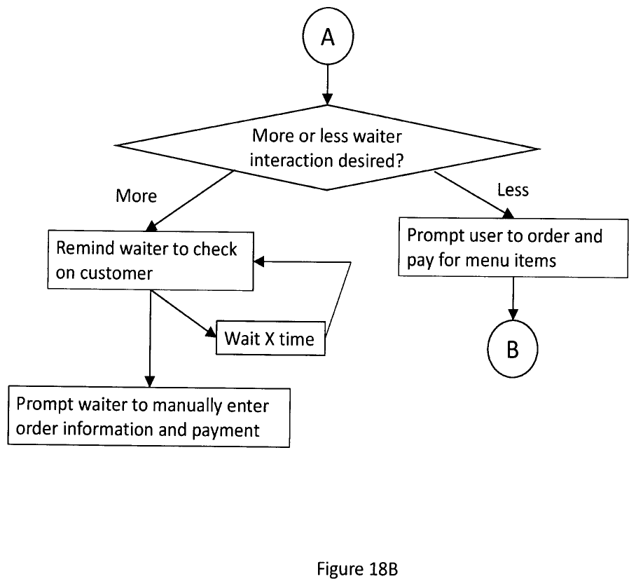

FIGS. 18 and 18B illustrate exemplary logic for operating the systems and methods shown and/or described herein. Upon registration, each restaurant may specify, such as in the restaurant information stored at the database 11, whether it offers minimal, mid-level, full-service dining, combinations thereof, or the like. Examples of minimal service dining include, but are not necessarily limited to, fast food, food trucks, carry out, combinations thereof, or the like. Examples of mid-level service dining include, but are not necessarily limited to, fast-casual restaurants, buffets, counter service, combinations thereof, or the like. Examples of full-service dining include, but are not necessarily limited to, dine-in restaurants, fine dining, combinations thereof, or the like. Restaurant classification may be self-assigned, assigned by an administrator, or assigned by default, and may be changed.

Upon selection of a minimal service dining restaurant at the restaurant selection feature 24, the customer may be automatically prompted with the food selection feature 30 at the customer device 12 along with any associated features shown and/or described herein. Subsequently, the customer may be automatically prompted with the order summary and status feature 32, payment option 34, and feedback feature 36 along with any associated features shown and/or described herein.

Upon selection of a mid-level service dining restaurant at the restaurant selection feature 24, the customer may be automatically prompted with the waiter identification feature 26, along with any associated features shown and/or described herein, before following the same, or similar, flow as the minimal service dining restaurant. In the background, the server 16 may monitor for customer selection of the waiter call option 28. If the waiter call option 28 is selected, a notification may be sent to the restaurant device 17 associated with the assigned waiter. In this way, the customer may place in-person orders or payments which are manually entered by the waiter at the restaurant device 17. For example, without limitation, upon such selection, the restaurant device 17 may be provided access to, or automatically be prompted with, the food selection feature 30 and/or payment feature 34.

Upon selection of a full-service dining restaurant at the restaurant selection feature 24, the customer may be automatically prompted with the reservation feature 25 and/or table selection feature 27, before the waiter identification feature 26. If the user has selected a sufficient level of more interaction at the dining preference selection tool 29, the waiter may be prompted and/or more frequently reminded, such as via electronic notification, to check on the assigned customer. The server 16 may, alternatively or additionally, be configured to automatically wait for manual entry of the order and/or payment information. The amount of time between reminders to the waiter may be adjusted based on the selection made by the customer at the dining preference selection tool 29 (e.g., longer wait where closer to less interaction on a sliding scale, shorter wait where closer to more interaction on the sliding scale) though such is not required. The order summary and status feature 32, payment option 34, and feedback feature 36 along with any associated features shown and/or described herein may be subsequently provided, though such is not required.

Where the user has selected a sufficient level of less interaction, the same, or similar, flow as the mid-level service dining restaurant may be followed after providing the virtual greeting 26.

The server 16 may be configured to monitor for changes in the user selection of the dining preference selection tool 29 and may adjust the followed logic accordingly.

Various data and other information shown and/or described herein may be electronically stored at the server 12, database 11, other location, or combinations thereof. Various computer instructions shown and/or described herein may be electronically executed at the server 12, one or more customer devices 12, one or more restaurant devices 17, combinations thereof, or the like.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may be personal computers, smartphones, tablets, databases, servers, or the like. The electronic connections and transmissions described herein may be accomplished by wired or wireless means.

What is claimed is:

1. A system for facilitating a mobile application based restaurant experience, said system comprising:
one or more databases;
one or more servers in electronic communication with the database;
a number of customer devices in electronic communication with the one or more servers, each associated with a customer;
a number of restaurant devices in electronic communication with the one or more servers, each associated with a restaurant and at least one waiter; and
executable software instructions stored at the one or more servers, which when executed, configure one or more processors to:
generate an electronic list of restaurants at a particular one of the number of customer devices associated with a particular customer;
receive a user selection of a particular one of the listed restaurants;
generate, at the particular customer device, a listing of available reservation times;
receive a user selection of one of the available reservation times;
electronically assign a particular waiter associated with the particular restaurant and a particular one of the number of restaurant devices to the particular customer;
generate, at the particular customer device, a virtual waiter greeting comprising a dining preference selection tool visually prompting the customer to select between less service interaction and more service interaction;
receive user input from the dining preference selection tool indicating user selection of more or less service interaction;
display, at the particular restaurant device, a new customer display comprising a visual indication of the user selection at the dining preference selection tool indicating the customer preference for more or less service interaction.

2. The system of claim 1 wherein:
said virtual waiter greeting comprises a photo of the assigned waiter and a name of the assigned waiter; and
said virtual waiter greeting is generated following receipt of an electronic notification indicating arrival of the particular customer associated at the particular restaurant.

3. The system of claim 1 wherein:
said virtual waiter greeting comprises an option to call the assigned waiter.

4. The system of claim 3 further comprising:
additional software instructions stored at the one or more servers, which when executed, configure the one more processors to:
receive an electronic notification regarding user selection of the option to call the assigned waiter; and
generate an electronic notification at the particular one of the number of restaurant devices associated with the assigned waiter indicating that the customer needs attention.

5. The system of claim 1 wherein:
said new customer display comprises a customer name and a table identifier.

6. The system of claim 1 further comprising:
additional software instructions stored at the one or more servers, which when executed, configure the one more processors to generate an electronic reminder notification at the particular one of the number of restaurant devices associated with the assigned waiter reminding the waiter to check in with the customer.

7. The system of claim 6 wherein:
said electronic reminder notifications are generated with a first frequency where said received user input from the dining preference selection tool indicates user selection of a desire for more service interaction; and
said electronic reminder notifications are generated with a second frequency which is less than the first frequency where said received user input from the dining preference selection tool indicates user selection of a desire for less service interaction.

8. The system of claim 1 further comprising:
restaurant information stored at said one or more databases in association with said restaurants, said restaurant information comprising a name and location for each of said restaurants; and
additional software instructions stored at the one or more servers, which when executed, configure the one more processors to:
receive a location for the particular one of the number of customer devices; and
generate, at the particular one of the number of customer devices, an electronic listing of the restaurants in a predetermined proximity of the received location comprising the particular restaurant.

9. The system of claim 8 further comprising:
additional software instructions stored at the one or more servers, which when executed, configure the one more processors to:
receive a user selection of the particular restaurant from the electronic listing of the restaurants;
generate an electronic listing of menu items associated with the particular restaurant;
receive a user selection of one or more of the menu items from the electronic listing of menu items; and
transmit said user selection to one or more of said number of restaurant devices associated with the particular restaurant.

10. The system of claim 9 further comprising:
menu items stored at said one or more databases in association with said restaurants; and
additional software instructions stored at the one or more servers, which when executed, configure the one more processors to:
generate an order page comprising the one or more of the menu items selected by the user and an associated total cost; and
receive and process user provided payment information for the associated total cost.

11. The system of claim 1 further comprising:
reservation data stored at the one or more databases indicating reservations associated with the restaurants, each reservation associated with a time;
operating hours data stored at the one or more databases indicating normal operating times associated with the restaurants;
additional software instructions stored at the one or more servers, which when executed, configure the one more processors to:
receive a reservation request from the particular one of the number of customer devices associated with the customer;
query the database for time slots within the operating hours data for the particular restaurant where no reservations data within a predetermined range are found for the particular restaurant;
generate a display at the particular one of the number of customer devices indicating the time slots;
receive a user selection of one of the time slots; and
update the reservation data to indicate the user selection of the one of the time slots.

12. The system of claim 11 further comprising:
additional software instructions stored at the one or more servers, which when executed, configure the one more processors to:
associate each of said reservations within said reservations data with a table identifier; and
generate a display at the particular one of the number of customer devices indicating the tables associated with table identifiers not found in the reservations data for the time slot.

13. The system of claim 1 further comprising:
login credentials stored at the one or more databases; and
additional software instructions stored at the one or more servers, which when executed, configure the one more processors to generate a dashboard display at an electronic device from which login credentials are received which are associated with administrator login credentials stored within said login credentials.

14. The system of claim 13 further comprising:
financial data stored at said one or more databases in association with the restaurants;
additional software instructions stored at the one or more servers, which when executed, configure the one more processors to:
generate financial information for the particular one of the restaurants at the dashboard;
receive an administrator selection of a coupon or promotion for sending to a target audience;
transmit a message comprising the coupon or promotion to each of the one or more customer devices associated with customers within the target audience.

15. The system of claim 1 wherein:
said number of customer devices and said number of restaurant devices comprise smartphones.

16. A system for facilitating a mobile application based restaurant experience, said system comprising:
at least one database comprising login data, restaurant data, and customer data, wherein said restaurant data comprises a restaurant identifier, a restaurant photo, a number of menu items, and a number of waiter identifiers, and wherein said customer data comprises a number of customer identifiers;
at least one server;
a number of customer personal electronic devices, each in electronic communication with the at least one server and associated with a respective customer;
a number of restaurant electronic devices in electronic communication with the at least one server and associated with a respective restaurant and a respective waiter; and
executable software instructions stored at electronic storage devices of the at least one server, which when executed, configure one or more processors of the at least one server to:
receive login information from a particular one of the number of customer devices associated with a particular customer;
query the at least one database to determine whether said received login information matches the stored login data;
receive a location from the particular one of the number of customer devices;
query the at least one database to retrieve restaurant data associated with locations within a given distance of the received location;
generate an electronic listing of restaurants in said retrieved restaurant data comprising said restaurant identifier and said restaurant photo for each of said restaurants in said listing of restaurants;
upon selection of a particular one of said restaurants in said listing of restaurants, retrieve and generate a listing of said number of menu items stored at said at least one database in association with said particular restaurant;
receive an electronic notification indicating arrival of said particular one of said number of customer devices at the particular one of the number of restaurants as indicated by the receipt of location information from said particular one of said number of customer devices within a predetermined distance of said location of said particular one of said number of restaurants as recorded in said restaurant data at said at least one database;
assign a particular waiter to said particular customer;
generate, for display at the particular one of the number of customer devices, a virtual server greeting comprising a particular one of said number of waiter identifiers associated with the assigned waiter and a dining preference selection tool visually prompting the customer to select between less waiter interaction and more waiter interaction;
receive a user selection at the dining preference selection tool indicating a user desire of more or less waiter interaction for said restaurant experience; and
display, at a particular one of the number of restaurant devices associated with the assigned waiter a new customer display comprising a particular one of said number of customer identifiers and a visual indication of the user selection at the dining preference selection tool indicating the customer preference for more or less server interaction.

17. The system of claim 16 further comprising:
additional executable software instructions stored at said electronic storage devices of the at least one server, which when executed, configure said one or more processors of the at least one server to:
generate electronic reminder notifications at the particular one of the number of restaurant devices associated with the assigned waiter reminding the waiter to check in with the customer with a particular frequency, wherein said frequency is set to a first level where said user selection at the dining preference selection tool indicates a desire for more waiter interaction, and wherein said frequency is set to a second level which is lower than the first level where said user selection at the dining preference selection tool indicates a desire for less service interaction;
receive a revised user selection at said dining preference selection tool; and
generate said electronic reminder notifications at a revised frequency based on said revised user selection.

18. The system of claim 17 wherein:
said dining preference selection tool comprises an electronic slider bar.

19. The system of claim 16 further comprising:
seating capacity information stored at said at least one database associated with said restaurants; and
additional executable software instructions stored at said electronic storage devices of the at least one server, which when executed, configure said one or more processors of the at least one server to:
generate a visual representation of tables for said particular restaurant based on said seating capacity information associated with said particular restaurant at said particular one of said number of customer devices;
visually indicate at least some of said visual representation of said tables as occupied at said particular one of said number of customer devices;
receive a user selection of an unoccupied one of said tables at said particular one of said number of customer devices for said restaurant experience wherein each of said waiters for said particular restaurant are assigned to certain of said tables for said particular restaurant, and wherein said waiter is assigned based on said user selection of said unoccupied one of said tables.

20. A system for facilitating a mobile application based restaurant experience, said system comprising:
a database comprising login data, restaurant data, and customer data, wherein said restaurant data comprises a restaurant identifier, a restaurant photo, a number of menu items, a number of waiter identifiers, and seating capacity information, and wherein said customer data comprises a number of customer identifiers;
a server;
a number of customer smartphones, each comprising an installed application, in electronic communication with the server, and associated with a respective customer;
a number of restaurant smartphones, each comprising the installed application, in electronic communication with the server, and associated with a respective restaurant and a respective waiter; and
executable software instructions stored at electronic storage devices of the server, which when executed, configure processors of the server to:
receive login information from a particular one of the number of customer smartphones associated with a particular customer;
query the at least one database to determine whether said received login information matches the stored login data;
receive a location from the particular one of the number of customer devices;
query the at least one database to retrieve restaurant data associated with locations within a given distance of the received location;
generate an electronic listing of restaurants in said retrieved restaurant data comprising said restaurant identifier and said restaurant photo for each of said restaurants in said listing of restaurants;
upon selection of a particular one of said restaurants in said listing of restaurants:
generate a visual representation of tables for said particular restaurant based on said seating capacity information associated with said particular restaurant at said particular one of said number of customer devices;
visually indicate at least some of said visual representation of said tables as occupied at said particular one of said number of customer devices;
receive a user selection of an unoccupied one of said tables at said particular one of said number of customer devices for said restaurant experience;
retrieve and generate a listing of said number of menu items stored at said at least one database in association with said particular restaurant; and
receive a user selection of a number of said menu items;
receive an electronic notification indicating arrival of said particular one of said number of customer devices at the particular one of the number of restaurants as indicated by the receipt of location information from said particular one of said number of customer devices within a predetermined distance of said location of said particular one of said number of restaurants as recorded in said restaurant data at said at least one database;
assign a particular waiter to said particular customer, wherein each of said waiters for said particular restaurant are assigned to certain of said tables for said particular restaurant, and wherein said waiter is assigned based on said user selection of said unoccupied one of said tables;
generate, for display at the particular one of the number of customer devices, a virtual server greeting comprising a particular one of said number of waiter identifiers associated with the assigned waiter and a dining preference selection tool visually prompting the customer to select between less waiter interaction and more waiter interaction;
receive a user selection at the dining preference selection tool indicating a user desire of more or less waiter interaction for said restaurant experience;
display, at a particular one of the number of restaurant devices associated with the assigned waiter a new customer display comprising a particular one of said number of customer identifiers and a visual indication of the user selection at the dining preference selection tool indicating the customer preference for more or less server interaction;
display, at said particular one of the number of restaurant devices associated with the assigned waiter said user selection of said number of said menu item;
generate electronic reminder notifications at the particular one of the number of restaurant devices associated with the assigned waiter reminding the waiter to check in with the customer with a particular frequency, wherein said frequency is set to a first level where said user selection at the dining preference selection tool indicates a desire for more waiter interaction, and wherein said frequency is set to a second level which is lower than the first level where said user selection at the dining preference selection tool indicates a desire for less service interaction;
receive a revised user selection at said dining preference selection tool; and
generate said electronic reminder notifications at a revised frequency based on said revised user selection.

21. A system for facilitating a mobile application based restaurant experience, said system comprising:
one or more databases comprising information regarding a number of restaurants, wherein each of said number of restaurants is associated with a service level selected from the group consisting of: less service or full-service;
one or more servers in electronic communication with the database;
a number of customer devices in electronic communication with the one or more servers, each associated with a customer;
a number of restaurant devices in electronic communication with the one or more servers, each associated with a restaurant and at least one waiter; and
executable software instructions stored at the one or more servers, which when executed, configure one or more processors to:
generate an electronic list of restaurants at a particular one of the number of customer devices associated with a particular customer;
receive a user selection of a particular one of the listed restaurants;
query the database for the particular restaurant to determine the associated service level for the particular restaurant;
if a determination is made that the restaurant is a less service restaurant;
generate a listing of menu options for the particular restaurant at the particular customer device;
receive a user selection of one or more of the menu options;
prompt the user to enter payment information;
process said user payment information;
provide an order summary; and
prompt the user to enter feedback information; and
if a determination is made that the restaurant is a full-service restaurant:
generate, at the particular customer device, a listing of available reservation times;
receive a user selection of one of the available reservation times;
electronically assign a particular waiter associated with the particular restaurant and a particular one of the number of restaurant devices to the particular customer;
generate, at the particular customer device, a virtual waiter greeting comprising a dining preference selection tool visually prompting the customer to select between less service interaction and more service interaction;
receive user input from the dining preference selection tool indicating user selection of more or less service interaction;
if user selection of less service interaction is received, proceed as if the particular restaurant is a less service restaurant; and
if user selection of more service interaction is received:
display, at the particular restaurant device, a new customer display comprising a visual indication of the user selection at the dining preference selection tool indicating the customer preference for more or less service interaction;
periodically generate, at the particular restaurant device, an electronic reminder to check on the particular customer; and
receive, at the particular restaurant device, a user selection of one or more of the menu options and payment information.
